(19) United States
(12) Patent Application Publication
(10) Pub. No.: US 2006/0277008 A1
(43) Pub. Date: Dec. 7, 2006

(54) Analysis of boundary and/or initial value problems in thin objects and spaces

(76) Inventor: Krishnan Suresh, Madison, WI (US)

Correspondence Address: DEWITT ROSS & STEVENS S.C., 8000 EXCELSIOR DR, SUITE 401, MADISON, WI, 53717-1914, US

(21) Appl. No.: 11/143,294

(22) Filed: Jun. 2, 2005

(51) Int. Cl. G06F 17/10

(52) U.S. Cl. 703/2

(57) ABSTRACT

A method for simplifying engineering analysis of CAD geometric models, one which retains much of the accuracy of detailed finite element (FE) analysis while avoiding its computational burdens, is described. A skeleton, such as an exact or approximate medial mesh, is defined within the model, and the skeleton is then meshed. Known field values (physical values of interest, and/or their derivatives) are then “projected” onto the skeleton, as by interpolation or coordinate transformation, and these field values and the governing equations for the model and its engineering problem are then used to solve for unknown field values across all or desired portions of the skeletal mesh. The newly-determined field values may then be projected outwardly from the skeletal mesh to the remainder of the geometric model, again via interpolation or other methods. The method is found to be particularly efficient and accurate (again in comparison to standard FE methods) when applied to thin geometric objects, e.g., metal or plastic sheet, ribbed plates, thin cavities in plastics-forming molds, etc.

### STATEMENT REGARDING FEDERALLY SPONSORED RESEARCH

This invention was made with United States government support awarded by the following agencies:

National Science Foundation (NSF) Grant No(s). DMI-0322134 The United States has certain rights in this invention.

### FIELD OF THE INVENTION

This document concerns an invention relating generally to methods for solution of boundary value problems in geometric models (e.g., CAD models and the like) via finite element and other analysis methods, and more specifically to boundary value problem analysis methods which are particularly applicable to thin objects (i.e., objects having at least one dimension which is small in relation to its other dimensions).

### BACKGROUND OF THE INVENTION

In engineering fields, geometric modeling of objects and the engineering analysis of the behavior of the modeled objects are extremely important activities. Modeling is generally performed by constructing a representation of an object's geometry on a computer (i.e., a CAD geometric model), with the representation including the “environment” of the object (that is, the object's boundary conditions, such as loads exerted on the object, temperatures on and around the object, and other physical and non-physical functional values). Governing equations, usually partial differential equations, are then presumed to govern the behavior of these functional values throughout at least a portion of the model; examples are the well-known Laplace, Poisson, Navier, Helmholtz, Navier-Stokes, Stokes, Maxwell, Heat, Elasticity, and Fluid equations. The analysis of the model's behavior is then usually also performed by computer, with the goal of predicting the modeled object's physical behavior based on the boundary conditions defined for the geometric model. In general, this involves determining physical functional values and/or their derivatives everywhere in the geometric model, both on its boundaries and in its interior—these values and derivatives being referred to herein as “field values”—based on the known boundary conditions defined at isolated locations on the model. Additionally, in situations where the field values vary over time (with field values at one or more locations being known at one or more times, in which case these field values may be referred to as “initial values” or “initial-boundary values”), analysis may involve determining field values at one or more locations at desired times. The two activities of modeling and analysis are highly interrelated in that modeling is the prerequisite for analysis, while results of analysis are often used for further modeling.

Most geometric models and analysis-related functions are represented in a piecewise fashion, which requires discretization of the model (e.g., construction of a mesh or grid) into finite elements that conform to and approximate the overall model. Since finite element analysis is computationally expensive—it requires fairly significant computer runtime and memory allocation—it is often desirable to simplify finite analysis methods whenever possible, and many simplification approaches are known for various types of models and analyses. However, some types of models and analyses have proven resistant to effective simplification. One area of particular difficulty is with thin models: models (or portions thereof) having one or more dimensions which are significantly smaller than its other dimensions, such as plates, fins, flanges, webs, etc. Unless the geometries of the thin models are very simple (e.g., as in plates having opposing planar surfaces and uniform thickness), thin models remain relatively resistant to simplification because all known methods for simplifying their analyses tend to fail, to return inaccurate or impossible results, or to require substantial user intervention. To illustrate, perhaps the most popular simplification for a thin model is to apply what is known as “dimensional reduction”: to eliminate one or more spatial variables from the governing equation in such a manner that significant computational gains result. A surface known as a “mid-plane” or “mid-surface” may be defined throughout the thickness of the thin model; for example, in the hypothetical plate of uniform thickness, a mid-surface might be defined halfway between the opposing planar surfaces of the plate. If solutions are then applied which have low computational complexity (e.g., low-order polynomials) in the thickness variable, the 3-D problem over the thin model is effectively reduced to a 2-D problem over the mid-plane/mid-surface. Mid-surface dimensional reduction has been extensively investigated, and its computational merits are well documented (see, e.g., Reissner, E., “Reflections on the Theory of Elastic Plates”, Journal of Applied Mechanics, vol. 38, no. 11, pp. 1453-1464 (1985)).

Unfortunately, mid-surface dimensional reduction has limitations when applied to geometrically complex (but thin) solids. This is why conventional CAD packages, when used for analyses of thin models or thin portions of models, will often display a warning box noting that analyses may be erroneous for other than simple thin parts. To illustrate, in a plate which is locally thin everywhere, but which has a sudden step-wise decrease in thickness (as by having one of its opposing surfaces suddenly drop inwardly), the mid-surface generated in the thicker section is disjoint with the mid-surface of the thinner section. There is no readily accepted method of joining them, so manual intervention is often needed to create a connected mid-surface on which a dimensionally reduced analysis may be posed. Such intervention is generally cumbersome and error-prone, as well as being theoretically questionable, making automated engineering analysis of thin models difficult. This difficulty is not trivial, since some fields of industry—such as fields dealing with sheet metal products, or molded thin-walled plastic items—thereby suffer severe limitations in their ability to use CAD analyses. As a result, designers in these fields often have little choice but to rely on inaccurate CAD analyses, and supplement them with procedures such as frequent prototyping and testing, which can lead to extreme expense and delay.

A more recently proposed alternative to the “mid-surface” dimensional reduction method is the Medial Axis Reduction method (Suresh, K., “Generalization of the mid-element based dimensional reduction,” Journal of Computing and Information Science in Engineering 3(4): 308-314.(2003)), wherein the mid-surface of an model is replaced with its medial axis (i.e., the governing equation is defined on the medial axis, rather than on the mid-surface). The medial axis of an object, sometimes referred to as the “skeletal representation,” is an unambiguous geometric characteristic of any two-dimensional or three-dimensional object, and can be defined by two entities, namely a medial axis (skeleton) and a radius function (Blum, H., and Nagel, R. N., “Shape description using weighted symmetric axis features,” Pattern recognition, 10: p. 167-180 (1978); Sherbrooke, E. C., and Patrikalakis, N. M., “Differential and Topological Properties of Medial Axis Transforms,” Graphical Models and Image Processing, 58(6): p. 574-592 (1996); Choi, H., Choi, S., Moon, H., “Mathematical theory of medial axis transform, ” Pacific Journal of Mathematics 181(1): 57-88 (1997)). The medial axis can be informally defined as the locus of points inside the object that are equidistant and closest to at least two points on the boundary of the object. The radius function can be informally defined as the distance from a point on the medial axis to the boundary.

Unfortunately, the proposed Medial Axis Reduction method requires the explicit computation of the medial axis and the radius function. As is well known, this task poses both numerical and combinatorial challenges, especially in three-dimensional models. See, e.g., Etzion, M., and Rappoport, A., “Computing Voronoi Skeletons of a 3-D Polyhedron by Space Subdivision,” Computational Geometry 21: 87-120 (2002); Dey, T. K., Woo, H. Zhao, W., “Approximate medial axis for CAD models,” Proceedings of the eight ACM Symposium on Solid Modeling and Applications, Seattle (2003); Culver, T., Keyser, J., and Manocha, D., “Exact computation of the medial axis of a polyhedron, ” Computer Aided Geometric Design 21(1): 65-98 (2004); Yang, Y., Brock, O., Moll, R. N., “Efficient and robust computation of an approximated medial axis,” ACM Symposium on Solid Modeling and Applications, Genoa, Italy (2004). Thus, any advantages attained by use of the medial axis reduction method can largely be offset by its computational disadvantages. It would therefore be useful to have available alternative methods for accurately performing analyses of boundary and/or initial value-problems on thin objects in an accurate and computationally efficient manner.

### SUMMARY OF THE INVENTION

The invention involves a methodology, e.g., a computerized routine, which is intended to at least partially solve the aforementioned problems (though the invention is also regarded as encompassing devices which implement the methodology, e.g., CAD systems and/or CAD software). To give the reader a basic understanding of some of the advantageous features of the invention, following is a brief summary of a preferred version of the methodology, with steps in the preferred version being schematically illustrated in FIGS. 1-6. As this is merely a summary, it should be understood that more details regarding the preferred method may be found in the Detailed Description set forth elsewhere in this document. The claims set forth at the end of this document then define the various versions of the invention in which exclusive rights are secured.

Given a two-dimensional or three-dimensional CAD geometric model having known field values defined on at least one portion of the model, the method allows determination of unknown field values on the model. A simple exemplary two-dimensional CAD geometric model is illustrated in FIG. 1a at 100, with known field values being provided as defined temperatures on opposing left and right hand sides of the model, and some defined heat flux entering the top surface. Thus, the user of the CAD system may wish to know heat and temperature values elsewhere on the model. It should be understood that the model may not represent a solid, e.g., the model may represent a cavity through which liquid (such as molten metal or plastic), vapor, or gas is resting, flowing, solidifying, condensing, etc. Further, while the method is highly beneficial for application to thin geometric models (i.e., those having one or more physical dimensions which are far smaller than the remaining dimensions), it can be used on non-thin (thick) models as well.

To obtain such unknown field values, a skeleton is first defined in the geometric model, with the skeleton being defined along points which are located at least substantially equidistantly from adjacent surfaces of the model. An example of such a skeleton is illustrated at 102 in FIG. 1b, which illustrates points a and b on the skeleton 102 which are equidistant from adjacent sides of the model 100. (Note that the skeleton is not the same as a mid-surface, particularly insofar as it includes junctures at which portions of the skeleton branch off from each other.) In particular, the skeleton 100 is usefully defined by the medial axis of the model 100, i.e., the locus of points inside the model 100 which are equidistant and closest to at least two points on the boundary of the model 100 (with a further discussion of the medial axis being provided later in this document). Beneficially, the skeleton need not be precisely defined, e.g., a medial axis need not be exactly computed over the model 100 (with such exact computations being difficult and computationally burdensome). It is sufficient if the skeleton is only approximately defined, and this can be done (for example) by executing algorithms for identifying the medial axis of the model 100, but allowing the user of the CAD system to specify an acceptable degree of error for the medial axis determination. Thereafter, once a medial axis (or other skeleton) for a model 100 is determined to the specified degree of accuracy, the process for defining the skeleton can be halted without further burdensome calculations.

As depicted in FIG. 1c, the skeleton is then discretized (“meshed”) into elements, such as segments in the case of the two-dimensional model 100 having a skeleton 102 defined by one-dimensional segments. (In the case of a three-dimensional model having two-dimensional skeleton sections, the discrete elements might be defined by triangular cells, quadrilateral cells, etc.). This can be done via any known discretization methods, and can even be wholly or partially automated.

The known field values are then “projected” onto the skeleton: presumed field values are defined on one or more of the elements of the skeleton, with each of the presumed skeletal element field values being dependent on one or more of the known field values. These presumed field values are preferably at least reasonable approximations of the true field values on the skeleton (which will often be unknown), and since they need only be approximations, these presumed values can be derived in several ways. As an example, FIG. 1d(i) shows field values presumed at points a and b by simply adopting those values from the closest boundary points. As another example, FIG. 1d(ii) shows field values presumed at points a and b if it is assumed that the field values are parabolically distributed about point a. Other methods of assigning presumed values to the skeletal elements could be used instead. Rather than adopting any particular rule specifying how the presumed field values are to be defined, it can be useful to allow a CAD system user to define how the presumed axial field values are to be defined on the medial axis/skeleton of the model.

The presumed field values on the skeletal elements can then be used to solve for field values across the skeleton using known finite element solution techniques, as schematically illustrated in FIG. 1e. As a result, the distribution of field values across the skeleton will be known.

The calculated field values on the skeleton can then be “projected” back outwardly from the skeleton to any area(s) away from the skeleton to define presumed field values at these points as well, thereby allowing field values to be defined across the entirety of the model 100 (or at least at desired portions of the model 100). This can be done, for example, by simply utilizing the same or a similar field value distribution as the one used to define field values on the skeletal elements in the first place, but instead using the distribution to define field values off of the skeleton. This process is schematically illustrated in FIGS 1f(i) and 1f(ii) for the distributions assumed in FIGS. 1d(i) and 1d(ii).

The method can be used to define field values across the entirety of a CAD geometric model, or only a portion of the model. For example, in a CAD model having one or more thick sections and also one or more thin sections, conventional finite element methods might be used at the thick sections, and the present method might be used on the thin sections. In this case, the solution structure would assume that the field values at the adjoining boundaries of the thick and thin sections must match.

Further advantages, features, and objects of the invention will be apparent from the following detailed description of the invention in conjunction with the associated drawings.

### BRIEF DESCRIPTION OF THE DRAWINGS

FIGS. 1a-1d(ii), which will be collectively referred to as FIG. 1, presents a simplified schematic depiction of the process of the invention as applied to an exemplary two-dimensional geometric model (a rectangle), wherein:

FIG. 1a shows the geometric model with applied boundary conditions (field values);

FIG. 1b shows the skeleton (here the exact medial axis) of the geometric model;

FIG. 1c shows the discretized (meshed) skeleton of the geometric model;

FIG. 1d(i) and 1d(ii) schematically illustrate projection of field values defined on the boundary of the geometric model onto the skeletal mesh, via a “collapse” of the field values onto the skeletal mesh along directions normal to the boundaries (FIG. 1d(i)), and via a parabolic collapse of the field values onto the skeletal mesh (FIG. 1d(ii));

FIG. 1e schematically illustrates solution of the engineering problem on the skeletal mesh, i.e., previously unknown field values are calculated across all or desired portions of the skeletal mesh based on the projected field values and the governing partial differential equations;

FIG. 1f schematically illustrates the projection of the field values determined on the skeletal mesh back outwardly toward the boundaries or other portions of the geometric model away from the skeleton.

FIGS. 2a-2c, which will be collectively referred to as FIG. 2, present a simplified schematic depiction of steps of the process of the invention as applied to an exemplary three-dimensional geometric model (a cuboid), wherein:

FIG. 2a presents a perspective view of the geometric model 200 and its skeleton 202, here its medial axis.

FIG. 2b presents a perspective view of the geometric model 200 with its skeleton 202 discretized into triangular elements.

FIG. 2c presents a perspective view of the geometric model 200 and one of its triangular elements, depicting how known field values (if any) defined on the boundaries of the model 200 may be projected onto the element for subsequent use when solving for unknown field values across the discretized skeleton.

FIG. 3 presents a perspective view of the geometric model of FIGS. 2a-2b and its discretized skeleton where the boundary of the model is perturbed, thereby illustrating the effect of complex model geometry on the skeleton and its mesh.

FIGS. 4a and 4b, which will be collectively referred to as FIG. 4, present a slightly more complex geometric model and its skeletal mesh, which are considered in the later EXAMPLE 2.

FIGS. 5a-5c, which will be collectively referred to as FIG. 5 and which are considered in the later EXAMPLES 3 and 4, present:

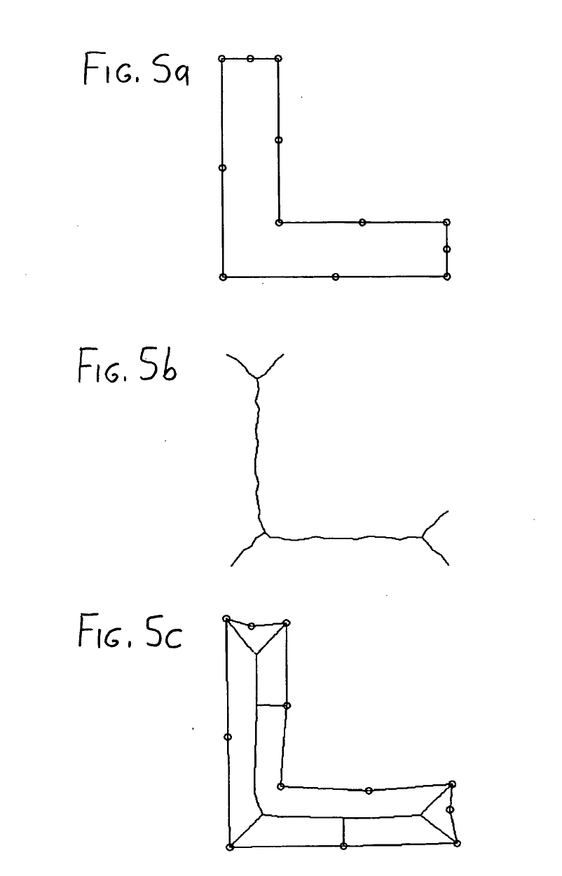

In FIG. 5a, a simple two-dimensional geometric model (an L-shaped bracket);

In FIG. 5b, the “approximate” skeleton for the model, actually the exact medial axis with artificial distortion; and

In FIG. 5c, a view of the model with its boundaries distorted, and the skeleton (medial axis) computed from these distorted boundaries.

### DETAILED DESCRIPTION OF PREFERRED VERSIONS OF THE INVENTION

1. Defining a Skeleton on the Geometric Model

Initially, to execute the method described above, it is useful to review some of the known strategies for determining the medial axis of a modeled object. Several medial axis determination strategies can be regarded as exact determination methods, i.e., they compute the exact medial axis of solids within machine precision. See, e.g., Srinivasan, V., and Nackman, L. R., “Voronoi Diagram of Multiply Connected Polygonal Domains I: Algorithm,” IBM Journal of Research 31(3): 1-31 (1987); Dutta, D., Hoffmann, C. M., “A Geometric Investigation of the Skeleton of CSG Objects,” Proceedings of the ASME Conference on Design Automation (1990); Goldak, J., Yu, X., Knight A., Dong. L., “Constructing discrete medial axis of 3-D objects, ” International Journal of Computational Geometry and its Applications 3: 327-339 (1991); Milenkovic, V., “Robust construction of the Voronoi diagram of a polyhedron,” Proc. 5th Canadian Conference on Computational Geometry (1993); Reddy, J. M., and Turkiyyah, G. M., “Computation of 3-D skeletons using a generalized Delaunay triangulation technique,” Computer Aided Design 27: 677-694 (1995); and Etzion, M., and Rappoport, A., “Computing Voronoi Skeletons of a 3-D Polyhedron by Space Subdivision,” Computational Geometry 21: 87-120 (2002). Such algorithms are highly efficient for simple 2-D and 3-D solids, but are computationally difficult to generalize to more complex non-polyhedral solids due to the algebraic and combinatorial complexity of the medial axis.

Other strategies can be regarded as approximate determination methods, which sacrifice exactness for (generally) easier computation. These approximation methods include:

Tessellation: A particularly effective algorithm for obtaining an approximate medial axis is described in Teichmann, M., Teller, S., “Polygonal approximation of Voronoi diagrams of a set of triangles in three dimensions,” Laboratory of Computer Science, MIT (1997).

Delaunay Triangulation: A set of points on the boundary of the model is subjected to Delaunay triangulation, followed by curve tracing/fitting. Prototypical versions of the invention have used this methodology to determine approximate medial axes for three-dimensional geometric models, e.g., those medial axes shown in FIG. 2 onward. See, e.g., Sheehy, D. J., Armstrong, C. J., Robinson, D. J., “Computing the medial surface of a solid from a domain delaunay triangulation, ” IEEE Transactions on Visualization and Computer Graphics 2(1): 44-61 (1996); Turkiyyah, G. M., Storti, D. W., Ganter, M., Chen, H., Vimawala, M., “An Accelerated Triangulation Method for Computing the Skeletons of Free-Form Solid Models,” Computer Aided Design 29(1): 5-19 (1997).

Tracing: Points on the medial axis are traced through iterative solution of constraint equations. See, e.g., Sherbrooke, E. C., Patrikalakis, N. M., Brisson, E., “An algorithm for the medial axis transform of 3-D polyhedral solids,” IEEE Transactions on Visualization and Computer Graphics 2(1): 62-7 (1995); Ang, P. Y., and Armstrong, C. G., “Adaptive Shape-Sensitive Meshing of the Medial Axis,” Engineering with Computers 18: 253-264 (2002).

Thinning algorithms: Starting with a voxel-discretization of free-space, thinning algorithms essentially “strip” voxels starting at the boundary to result in an approximate medial axis transform. See, e.g., Lam, L., Lee, S. W, Suen, C. Y., “Thinning methodologies, a comprehensive survey,” Transactions on Pattern Analysis 14(9): 869-885 (1992).

Sampling algorithms: These methods allow computation of an approximate medial axis from a boundary sampling, with a concomitant tradeoff in accuracy vs. computational speed. See, e.g., Amenta, N., Choi, S., Kolluri, R., “The Power Crust,” ACM Symposium on Solid Modeling and Applications, ACM (2001); Dey, T. K., Woo, H. Zhao, W., “Approximate medial axis for CAD models,” Proceedings of the 8th ACM Symposium on Solid Modeling and Applications, Seattle (2003); Yang, Y., Brock, O., Moll, R. N., “Efficient and robust computation of an approximated medial axis,” ACM Symposium on Solid Modeling and Applications, Genoa, Italy (2004).

PDE-based methods: These methods use diffusion or Hamilton-Jacobi partial differential equations to detect and extract approximate medial axis transforms. See, e.g., Siddiqi, K., Bouix, S., Tannenbaum, A., Zucker, S., “The Hamilton-Jacobi skeleton,” International Conference on Computer Vision (ICCV) (1999)).

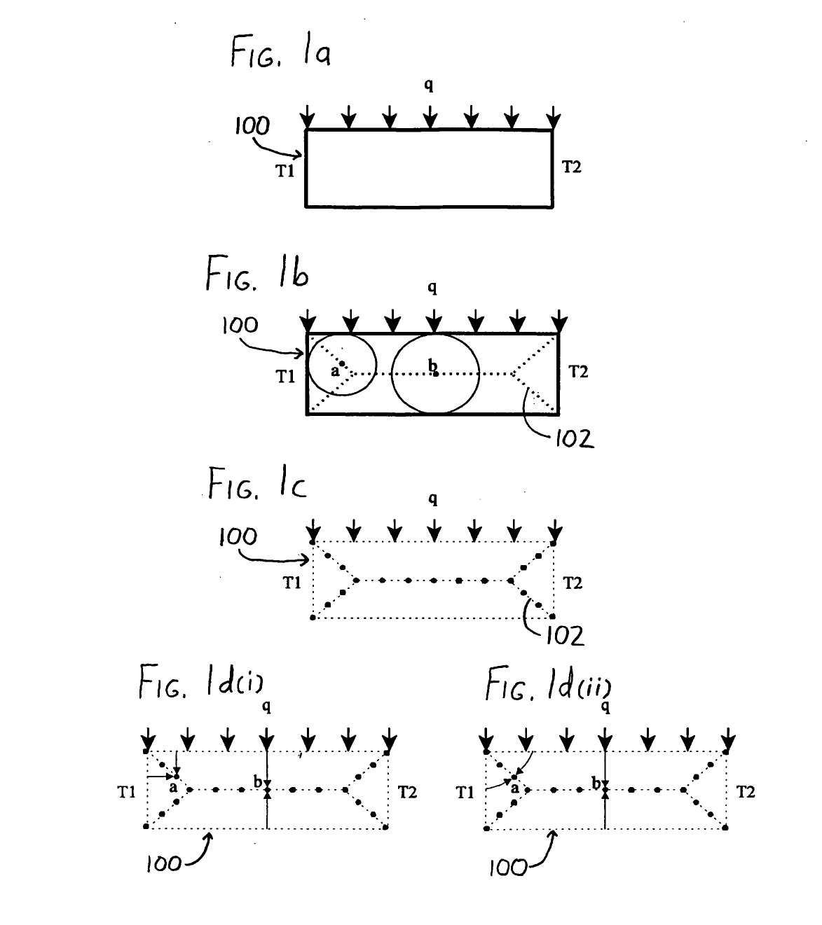

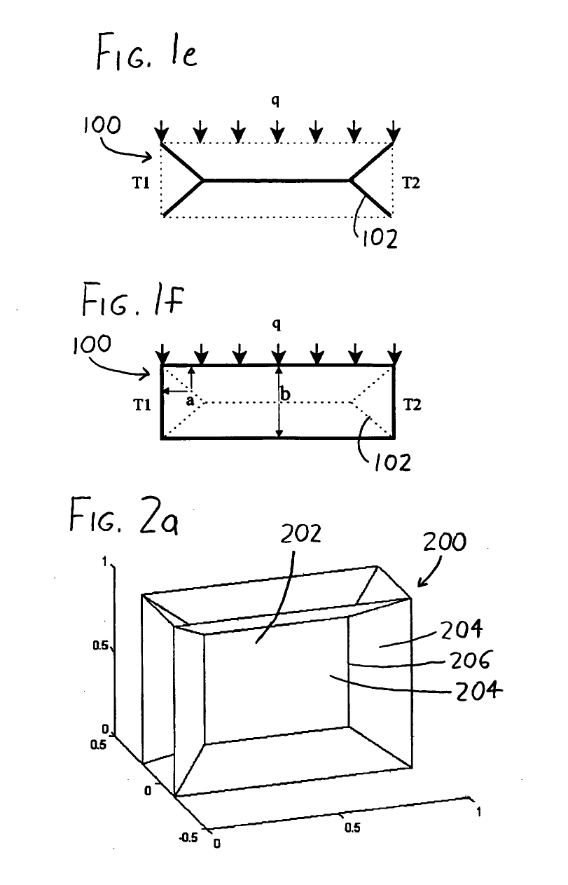

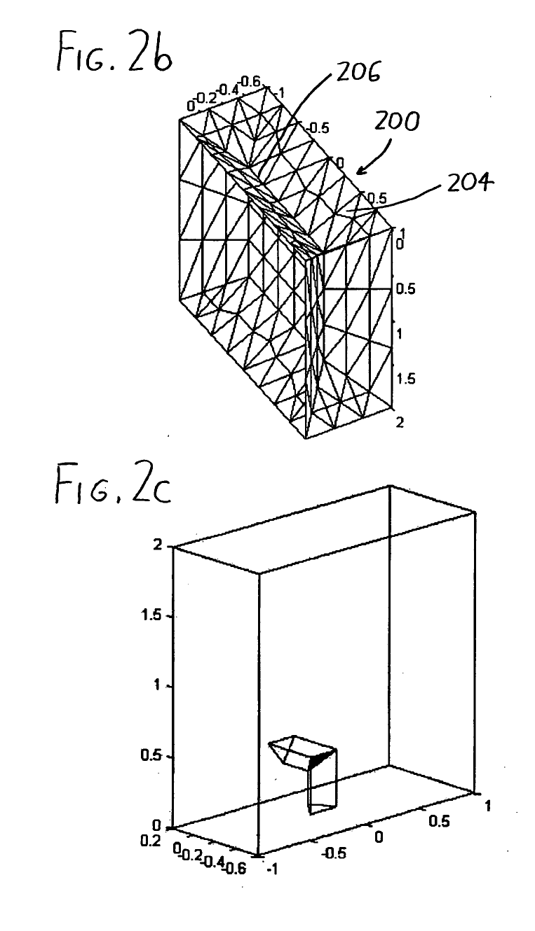

Any of the foregoing medial axis determination methods (or others) can be used in the invention to define a skeleton (an exact or approximate medial axis) in a given two- or three-dimensional geometric model. Note that throughout this document, the term “medial axis” is used to refer to both medial axes in two-dimensional models and to medial surfaces in three-dimensional models. In a three-dimensional object, such as the cuboid geometric model 200 of FIG. 2, the medial axis 202 is actually a collection of medial surfaces 204 bounded by medial edges 206, some of which join to the medial edges 206 of other medial surfaces 204. (Note that the cuboid geometric model 200 of FIG. 2 can effectively be regarded as a three-dimensional version of the rectangular geometric model 100 of FIG. 1, wherein the model 100 is merely the top surface of the model 200.)

Beneficially, several of the approximate medial axis determination methods allow the medial axis of a geometric model to be defined to some desired degree of accuracy, with higher accuracy generally incurring higher computational time. Thus, as previously noted, it can be useful to allow a user to specify some desired degree of accuracy in the definition of the skeleton, and the invention then need not incur any computational burdens beyond those necessary to obtain the specified level of accuracy. However, it is often possible to generate the exact medial axis for a two-dimensional model with fairly minimal computational burden. Thus, it can also be useful to simply generate the exact medial axis for use as the skeleton where the geometric model in question is two-dimensional, and generate an approximated medial axis (to some user-defined degree of accuracy) for use as the skeleton where the geometric model in question is three-dimensional.

2. Discretization of the Skeleton

Next, the skeleton is discretized (meshed) into connected tesselated elements, e.g., with segments in the case of (effectively) one-dimensional skeletons (as in FIG. 1) or triangles or quadrilaterals (as in FIG. 2). It should be understood that other elements are possible. The mesh is preferably defined with element coarseness, regularity, etc. such that if the inverse medial axis transform was applied to the nodes of the mesh (i.e., if the nodes of the mesh were regarded as defining the medial axis of the modeled object), the modeled object would be closely approximated. The mesh should be connected, and thus some of the medial axis approximation techniques that do not guarantee connectedness (i.e., that may result in an approximate medial axis defined by unconnected segments/surfaces) are preferably avoided. Connectedness is desired since an engineering problem posed over a connected set—the original solid—can only be accurately reduced to a problem over a connected set. However, while a connected medial axis and mesh are desired, it is emphasized that the topology of the medial axis and its mesh need not match the topology of the exact medial axis. In other words, extraneous branches, which are often unavoidable when computing an approximate medial axis, are acceptable so long as the reconstructed object approximates the original object. The closer the approximation, the more accurate the final results.

Given the foregoing discussion, a skeletal mesh with triangular elements can be formally defined as follows. Initially, as discussed in Suresh, K., “Generalization of the mid-element based dimensional reduction,” Journal of Computing and Information Science in Engineering 3(4): 308-314 (2003), a medial axis for a model can be generally defined as the set of points:
p(s,t,κ)=m(s,t)+d^{±}(s,t)κ (1)
where the directors d^{±} (s,t) are a pair of vectors from a medial point to the two nearest boundary points, and κ(0≦κ≦1) is a “radius function parameter.” A skeletal mesh can then be defined as a triangulation of a medial axis (exact or approximate) where each triangular facet \overline{m}ⱼ(s,t) is a linear interpolation of three sampled medial points

$$\begin{matrix}{m}_{j 1} , {m}_{j 2} \& {m}_{j 3} \text{:} \\ {\overline{m}}_{j} ( s , t ) = {\sum }_{i = 1}^{3} {N}_{i} ( s , t ) {m}_{ji}\end{matrix} \qquad ( 2 )$$

where standard linear interpolation functions are employed:
N₁(s, t)=1−s−t; N₂(s, t)=s; N₃(s, t)=t
0≦s≦1; 0≦t≦1−s
In addition, the directors defined in Equation (1) are also linearly interpolated within each facet:

$${\overline{d}}_{j}^{\pm } ( s , t ) = {\sum }_{i = 1}^{3} {N}_{i} ( s , t ) {d}_{ji}^{\pm } \qquad ( 3 )$$

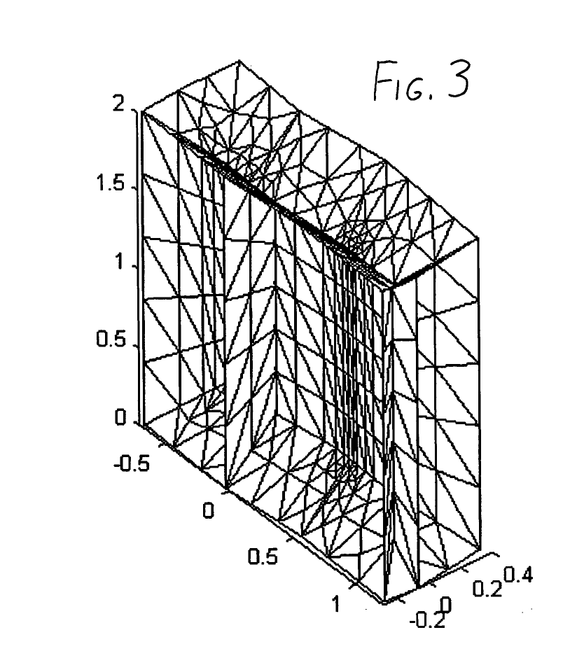

FIG. 2b illustrates the skeletal mesh of the cuboid of FIG. 2a. FIG. 3 illustrates the effect on the skeletal mesh when the boundary of the cuboid of FIG. 2a is perturbed. Note that numerous additional branches arise in the skeleton (medial axis), and as a result, in its mesh.
3. Projection of known Field Values onto Skeletal Elements

It was previously noted, and expressed in Equation (1), that the boundary of a model will define the model's skeleton. Conversely, a well-defined skeleton (and its mesh) will allow reconstruction of its geometric model, either exactly or approximately (depending on the degree of accuracy to which the skeleton was defined). This principle provides an easily automated methodology for projecting known field values onto corresponding skeletal elements. Following Equation (1), two cells Dⱼ^{±} extending from each triangular facet back to the model boundaries can be defined as:
Dⱼ^{±}=\overline{m}ⱼ(s,t)+κ\overline{d}ⱼ^{±}(s,t) (4)
To illustrate, FIG. 2c an element from the skeletal mesh of FIG. 2b showing the pair of cells Dⱼ^{±} projected to its adjoining model boundaries. Equation (4) may be viewed as a coordinate transformation (s, t, κ)→(x, y, z) in that each set of parameters (s, t, κ) for an element has a corresponding point in the (x, y, z) domain of the model. This implies that an engineering problem over the model in the (x, y, z) domain can be decomposed into a sum of problems over the cells Dⱼ^{±} in the (s, t, κ) domain by inverting the Jacobian J associated with the coordinate transformation of Equation (4) (see Bronshtein, I. N., Semendyayev, K. A., Handbook of Mathematics, New York, Van Nostrand Reinhold (1985)):

$${J}^{\pm } = [ \begin{matrix}\frac{\partial {x}^{\pm }}{\partial s} & \frac{\partial {x}^{\pm }}{\partial t} & \frac{\partial {x}^{\pm }}{\partial κ} \\ \frac{\partial {y}^{\pm }}{\partial s} & \frac{\partial {y}^{\pm }}{\partial t} & \frac{\partial {y}^{\pm }}{\partial κ} \\ \frac{\partial {z}^{\pm }}{\partial s} & \frac{\partial {z}^{\pm }}{\partial t} & \frac{\partial {z}^{\pm }}{\partial κ}\end{matrix} ] \qquad ( 5 )$$

Note that the foregoing projection method for assigning known field values to corresponding skeletal elements in essence “collapses” known field values onto skeletal elements in a straightforward fashion, as can also be seen in FIG. 1d(i). It is also possible to utilize more complex coordinate transformation schemes, e.g., one such as that illustrated in FIG. 1d(i). Since different transformation schemes may provide different degrees of accuracy in different problems and geometries, it is preferable that in versions of the invention provided in CAD systems, a user would be allowed to select his/her preferred transformation scheme rather than being limited to the one described above. Field values may be projected to the skeleton in other ways as well, e.g., by simply performing (transfinite) interpolation of known field values to the skeleton in accordance with some predicted or desired distribution.

3. Solution of Governing Partial Differentail Equations Over the Skeletal Mesh to Determine Filed Values Everywhere

The partial differential equations and boundary conditions for the problem in question, now set in the domain of the model's skeleton and its mesh, are then solved to obtain field values over the entirety of the skeleton (or over desired portions). By extension, using the foregoing coordinate transformations, the field values determined over the skeleton can be projected back outwardly to obtain field values on the model away from its skeleton.

To illustrate, consider the application of the invention to engineering problems where the partial differential equation and boundary conditions are of the form:
∇c∇u+au=f in Ω⊂Rⁿ
u|_{Γ}=û (6)
This class of problems is chosen for consideration because it applies to many of the most common engineering analysis problems in heat transfer, fluid mechanics, magnetostatics, and other fields. The partial differential equation of (6) can be reexpressed in a standard variational form as:

$$Min \prod = {\int }_{Ω}^{} [ c ∇ u \cdot ∇ + {au}^{2} - 2 fu ] ⅆ Ω \\ subject to \text{:} u {\text{\textbar}}_{Γ} = \hat{u} \qquad ( 7 )$$

To simplify the solution of (7), it is useful to define trial functions over the skeletal mesh. Such trial functions are well known in other contexts, see, e.g., Kantorovich, L. V., Krylov, V. I., Approximate Methods of Higher Analysis, New York, Interscience (1964); Vogelius, M., Babuska, I., “On a Dimensional Reduction Method. I. The Optimal Selection of Basis Function,” Mathematics of Computation 37(155): 31-46 (1981); Vasiliev, V. V. “Modern conceptions of plate theory, ” Composite Structures 48: 39-48 (2000); and Ainsworth, M., and Arnold, M., “Computable error bounds for some simple dimensionally reduced models on thin domains,” IMA Journal of Numerical Analysis 21: 81-105 (2001). As discussed in Strang, G., Fix., G. J., An Analysis of the Finite Element Method, Englewoods Cliff, N.J., Prentice Hall (1973), it is necessary to select trial functions that meet certain criteria related to:

(1) Dirichlet boundary conditions: The trial functions must satisfy Dirichlet boundary conditions imposed on the problem;

(2) Completeness criterion: A trial function must be a full polynomial, i.e., must contain all terms of a polynomial of fixed order; and

(3) Admissibility and conformance criterion: Depending on the underlying partial differential equation, the trial function must satisfy certain continuity requirements across adjacent sub-domains.

A large class of trial functions can be defined which possess the required mathematical properties. For simplicity, a simple linear trial function can be defined over each pair Dⱼ^{±}:
uⱼ^{±(}s,t,κ)=vⱼ(s,t)+[wⱼ^{±}(s,t)−vⱼ(s,t)]κ (8)
where vⱼ(s, t) are unknown functions defined over a skeletal element, and wⱼ^{±}(s,t) are known Dirichlet boundary conditions on the boundary segments of Dⱼ^{±}, obtained by setting κ=1 in Equation (4). If desired, higher polynomial-order extensions can be made to Equation (8) (as illustrated, for example, in).

The trial function of Equation (8) can then be substituted in Equation (7) and through routine symbolic integration, the variable κ can be eliminated, resulting in a dimensionally reduced problem over the skeletal mesh. The solution can then be obtained using standard techniques, and the field values determined over the skeletal mesh can then be projected from the skeletal mesh to the overall model by use of the inverse of the same (or a different) coordinate transform as the one used to assign known field values to the skeleton in the first place.

### EXAMPLE 1

To illustrate the foregoing method, consider a simple engineering analysis problem:
∇²u=0 in Ω
having boundary conditions u|_{Γ}=û, where Ω is a cuboid (as in FIG. 2) of dimension (1, 1, 2H), H<0.5, and the exact solution is u=û=x+y+z.

Since the cuboid domain is a simple one, the skeleton (medial axis) can be computed to machine-precision accuracy. Since the exact solution is linear, and since the trial function (Equation (8)) is linear, the computed solution u_{computed} should closely conform to u. TABLE 1 illustrates the results in the form of the maximum error e=max∥u−u_{computed}∥ over the entire skeletal mesh for various values of H.

TABLE 1

| H | e = max∥u − u_{computed}∥ |
|---|---|
| 0.25 | 3.21e⁻¹⁵ |
| 0.1 | 3.02e⁻¹⁵ |
| 0.05 | 1.65e⁻¹⁵ |

Note that as H grows smaller—i.e., as the cuboid grows thinner—the error grows smaller.

### EXAMPLE 2

Consider a slightly more complex problem:
∇²u=−1 in Ω

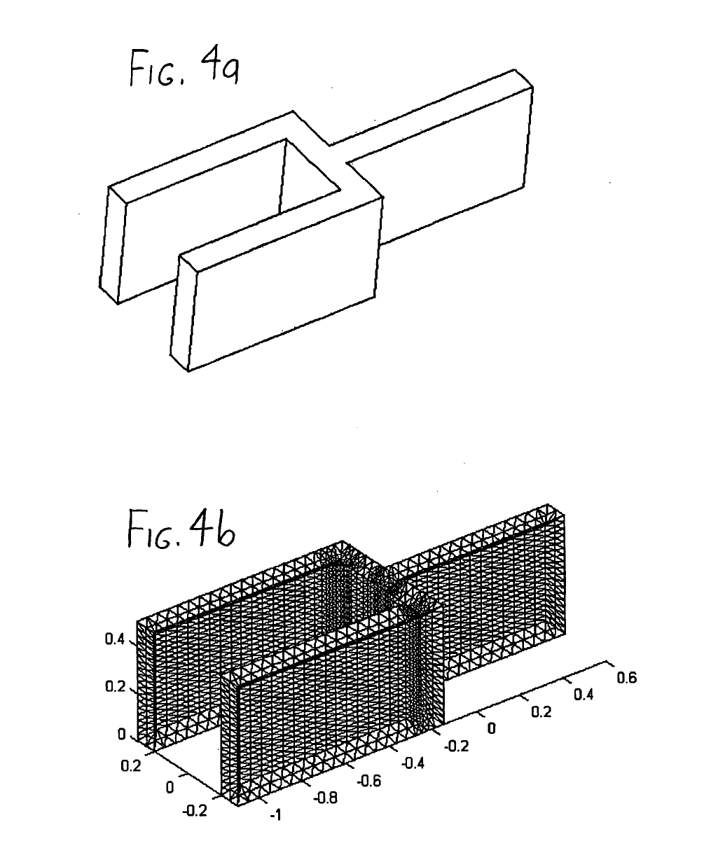

having boundary conditions u|_{Γ}=0, where Ω is the “tuning fork” shown in FIG. 4a (and having a skeletal mesh computed as in FIG. 4b). Since exact solutions for the posed problem are not available, the computed solution can be compared to a full 3-D finite element mesh solution calculated by use of FEMLAB (Comsol Inc., Burlington, Mass.), a popular CAD/CAE commercial software package. TABLE 2 compares the maximum value of the computed field on the skeletal mesh against the FEMLAB solution for two different values of H, and also presents the approximate CPU time for the two methods. Note that the CPU time for the skeletal mesh includes the time needed to calculate the medial axis and generate the mesh thereon.

TABLE 2

| H | | 3-D FEM | Skeletal Mesh |
|---|---|---|---|
| 0.2 | max∥u_{computed}∥ | 1.41e⁻³ | 1.7e⁻³ |
| | CPU Time (s) | 7.2 | 4.1 |
| 0.1 | max∥u_{computed}∥ | 3.1e⁻³ | 3.3e⁻³ |
| | CPU Time (s) | 18.4 | 4.3 |

Note from TABLE 2 that the loss in accuracy arising from use of the skeletal mesh is small, and it grows smaller as the local thickness of the solid grows smaller. Furthermore, if the error arising from the use of the skeletal mesh is regarded as being too high, the order of the trial function (Equation (8)) can be increased to yield higher accuracy, or other trial functions of different form (but potentially higher accuracy) might be used. The savings in CPU time, in comparison to a full FEM analysis, is substantial, and whereas the time required for full FEM analysis increases substantially as the local thickness decreases, only a minor increase occurs with the skeletal mesh.

### EXAMPLE 3

In the foregoing experiments/examples, the numerical axes were computed to a high degree of accuracy. Thus, the question remains whether computed solutions would still be acceptable if the medial axes were approximated. As per the observations in Hammerlin, G., Hoffmann, K. H., Numerical Mathematics, New York, Springer-Verlag (1991), it is expected that data perturbations would have minimal effect on the computed solution owing to the underlying elliptic nature of the partial differential equations noted at the outset of this document (as well as others). This is confirmed in the following experiment.

Consider the L-shaped bracket of FIG. 5a, which is subject to the Laplacian problem u=û=x+y+z. Then consider if each point on the exactly-computed medial axis (and its mesh) was artificially perturbed by a maximum magnitude of ε (as an example, see FIG. 5b). TABLE 3 compares the computed solution for the perturbed mesh against the exact solution.

TABLE 3
e = max∥u − u_{computed}∥

| | | |
|---|---|---|
| ε = 0.01 | ε = 0.001 | ε = 0.001 |
| 3.01e⁻² | 5.54e⁻³ | 1.1e⁻³ |

It is seen that as ε→0, the computed solution converges on the exact solution.

### EXAMPLE 4

It is then useful to consider the effects on the method of the invention when the model itself is subject to error. FIG. 5c presents the L-bracket of FIG. 5a with its boundary perturbed, and as a result, with a skeleton (here the approximate medial axis) having extraneous branches and branch points. TABLE 4 compares the computed solution for the perturbed boundary (and its resulting skeletal mesh) against the exact solution.

TABLE 4
e = max∥u − u_{computed}∥

| | | |
|---|---|---|
| ε = 0.01 | ε = 0.001 | ε = 0.001 |
| 6.6e⁻¹ | 4.95e⁻² | 1.45e⁻² |

It is again seen that as ε→0, the computed solution converges on the exact solution.

Further details regarding the invention, including formal proofs, can be found in Sinha, M., Suresh, K., “Simplified Engineering Analysis via Medial Mesh Reduction,” ACM Symposium on Solid Modeling and Applications (2005), and in Suresh, K., “Skeletal Reduction of Boundary Value Problems, ” Int'l. Journal of Numerical Methods in Engineering, to be published in 2005-2006, and these articles are incorporated by reference into this document.

The invention is not intended to be limited to the preferred versions described above, but rather is intended to be limited only by the claims set out below. Thus, the invention encompasses all different versions that fall literally or equivalently within the scope of these claims.

What is claimed is:

1. A computerized routine for determining unknown field values in a CAD geometric model having known field values defined on at least one portion of the model, the routine comprising the steps of:
a. defining a medial axis on the model;
b. discretizing the medial axis into elements;
c. defining presumed axial field values on one or more of the medial axis elements, each of the presumed axial field values being dependent on one or more of the known field values;
d. calculating axial field values on the medial axis elements, the calculated axial field values being dependent on one or more of the presumed axial field values; and
e. defining presumed field values on the model away from the medial axis, the presumed field values being dependent on one or more of the calculated axial field values.

2. The routine of claim 1 wherein at least a portion of the medial axis is automatically discretized into elements.

3. The routine of claim 1 further comprising the step of soliciting from a user a rule by which the presumed axial field values are defined on the medial axis of the model.

4. The routine of claim 1 further comprising the step of soliciting from a user a rule defining an acceptable degree of error by which the medial axis of the model is defined.

5. The routine of claim 1 wherein:
a. the CAD geometric model has at least two dimensions, and
b. the medial axis is defined within only a portion of the CAD geometric model, wherein this portion of the geometric model has one dimension which is substantially smaller than its other dimension(s).

6. A computerized routine for determining unknown field values in a CAD geometric model having known field values defined on at least one portion of the model, the routine comprising the steps of:
a. soliciting from a user a rule by which presumed axial field values are defined on a medial axis of the model, the presumed axial field values being dependent on one or more of the known field values; and
b. defining presumed field values on the model away from its medial axis.

7. The routine of claim 6:
a. further comprising the step of discretizing the medial axis of the object, and
b. wherein the presumed field values on the model away from its medial axis are defined in accordance with the presumed axial field values defined on the discretized medial axis.

8. The routine of claim 6 further comprising the step of soliciting from the user a rule defining an acceptable degree of error by which the medial axis of the model is defined.

9. The routine of claim 6 wherein:
a. the CAD geometric model has at least two dimensions, and
b. the medial axis is defined within only a portion of the CAD geometric model, wherein this portion of the geometric model has one dimension which is substantially smaller than its other dimension(s).

10. The routine of claim 6 further comprising the step, prior to the step of defining presumed field values on the model away from its medial axis, of calculating axial field values on the medial axis, wherein the calculated axial field values are dependent on one or more of the presumed axial field values.

11. The routine of claim 10 further comprising the step, prior to calculating axial field values on the medial axis, of discretizing the medial axis into elements.

12. The routine of claim 11 wherein the discretization of the medial axis into elements is at least partially automated, whereby elements are automatically defined on at least a portion of the medial axis.

13. A computerized routine for determining unknown field values in a CAD geometric model having known field values defined on at least one portion of the model, the routine comprising the steps of:
a. defining a skeleton within the model, the skeleton:
(1) being defined along points which are located at least substantially equidistantly from two or more points on the surface of the model, and
(2) including one or more junctures therein, wherein each juncture is situated between at least three subsections of the model;
b. discretizing the skeleton into elements;
c. determining field values at a portion of the model at which field values were previously unknown, with these field values being dependent upon the elements and the known field values.

14. The routine of claim 13 wherein the skeleton is defined along paths which at least substantially correspond to the medial axis of the model.

15. The routine of claim 14 further comprising the step of soliciting from the user a rule defining an acceptable degree of error by which the medial axis of the model is defined.

16. The routine of claim 13 wherein the step of determining field values at a portion of the model at which field values were previously unknown includes the substep of defining presumed field values on one or more of the elements of the skeleton, each of the presumed field values being dependent on one or more of the known field values.

17. The routine of claim 16 further comprising the step of soliciting from a user a rule by which presumed field values are defined on the skeleton, the presumed field values being dependent on one or more of the known field values.

18. The routine of claim 16 further comprising the substep of calculating field values on one or more of the elements of the skeleton, each of the calculated field values being dependent on one or more of the presumed field values.

19. The routine of claim 18 further comprising the substep of defining presumed field values on the model away from the skeleton, the presumed field values being dependent on one or more of the calculated field values on the elements of the skeleton.

20. The routine of claim 13 wherein at least a portion of the skeleton is discretized by automated meshing.

21. The routine of claim 13 wherein:
a. the CAD geometric model has at least two dimensions, and
b. the skeleton is defined within only a portion of the CAD geometric model, wherein this portion of the geometric model has one dimension which is substantially smaller than its other dimension(s).
